(19) United States
(12) Patent Application Publication
(10) Pub. No.: US 2020/0325019 A1
(43) Pub. Date: Oct. 15, 2020

(54) OZONE GENERATING ASSEMBLY AND OZONE GENERATOR

(71) Applicant: OURONG ENVIRONMENTAL TECHNOLOGY(SHENZHEN) CO., LTD, SHENZHEN (CN)

(72) Inventor: JERRY CHANG, SHENZHEN (CN)

(21) Appl. No.: 16/729,964

(22) Filed: Dec. 30, 2019

(30) Foreign Application Priority Data
Apr. 15, 2019 (CN) 201910299089.9

(51) Int. Cl. C01B 13/11

(52) U.S. Cl. CPC C01B 13/115; C01B 2201/90; C01B 2201/62; C01B 2201/14

(57) ABSTRACT

Provided is an ozone generating assembly, including a conductive pillar, an insulating sleeve sleeved on an outer periphery of the conductive pillar, a conductive sleeve sleeved on an outer periphery of the insulating sleeve, and insulating brackets arranged at two ends of the conductive pillar and used to arrange an inner wall of the conductive sleeve and an outer wall of the conductive pillar in parallel and at an interval. Air guiding holes are uniformly distributed on an outer peripheral surface of the conductive sleeve, and an ozone channel is formed by the air guiding holes and a gap between the inner wall of the conductive sleeve and an outer wall of the insulating sleeve. Further provided is an ozone generator, which is low in energy consumption, good in heat dissipation effect, and high in ozone release efficiency.

### CROSS-REFERENCES TO RELATED APPLICATIONS

This application claims priority to Chinese patent application No. 201910299089.9 filed on Apr. 15, 2019, the entire contents of which are hereby incorporated by reference.

### FIELD OF TECHNOLOGY

The following relates to the technical field of disinfection equipment, particularly to an ozone generating assembly and an ozone generator.

### BACKGROUND

Most of ozone generating assemblies in the related art are composed of a conductive pillar and a conductive sleeve sleeved on an outer periphery of the conductive pillar at an interval. Since a sleeve wall of the conductive sleeve is lack of an air guiding hole, and the conductive pillar and a conductive sleeve generate a relatively large amount of heat in the process of releasing ozone, the ozone generating assembly has extremely poor heat dissipation efficiency, and is not convenient for the outflow of the ozone. Due to the above disadvantages, an ozone generator mounted with the above ozone generating assembly also has extremely poor ozone release efficiency and relatively high energy consumption.

### SUMMARY

An aspect relates to an ozone generating assembly, which can effectively improve ozone release efficiency and heat dissipation efficiency of the ozone generating assembly.

Another aspect of the present disclosure is to provide an ozone generator, which is low in energy consumption, good in heat dissipation effect, and high in ozone release efficiency.

In order to achieve these aspects, the technical scheme adopted by the present disclosure is as follows.

Provided is an ozone generating assembly, including a conductive pillar, an insulating sleeve sleeved on an outer periphery of the conductive pillar, a conductive sleeve sleeved on an outer periphery of the insulating sleeve, and insulating brackets arranged at two ends of the conductive pillar and used to arrange an inner wall of the conductive sleeve and an outer wall of the conductive pillar in parallel and at an interval. Air guiding holes are uniformly distributed on an outer peripheral surface of the conductive sleeve, and an ozone channel is formed by the air guiding holes and a gap between the inner wall of the conductive sleeve and an outer wall of the insulating sleeve.

In one embodiment, each of the air guiding holes is a circular hole, a waist shaped hole, or an oval hole.

In one embodiment, a fist electrode is arranged at one end of the conductive pillar, and a second electrode is welded to the outer peripheral surface of the conductive sleeve.

In one embodiment, a ring shaped positioning groove is arranged on an outer periphery surface of the insulating bracket.

In one embodiment, the conductive pillar is a metal pillar. Each of the two ends of the conductive pillar is provided with a fixing shaft extending outward, and each of the insulating brackets is sleeved on a respective fixing sleeve.

In one embodiment, an end portion of the fixing shaft at one end of the conductive pillar is screwed to the first electrode.

Provided is an ozone generator, including:
an ozone generating assembly;
a case, configured to accommodate the ozone generating assembly and disposed with the ozone generating assembly;
an air guiding cover, covered on an outer periphery of the ozone generating assembly;
a fan, disposed in the case, connected to the air guiding cover and penetrating through the air guiding cover;
an electric control assembly, electrically connected to the fan and the ozone generating assembly.

In one embodiment, the electric control assembly includes a circuit board disposed above the air guiding cover, and a lithium battery arranged in the case and electrically connected to the circuit board.

In one embodiment, air inlets are uniformly distributed on a side wall on a periphery of the case, and an air exhausting hole is arranged on and configured to penetrate through a bottom surface of the case below the ozone generating assembly.

In one embodiment, a key is arranged on a middle portion of an upper surface of the case, and electrically connected to the circuit board.

The advantageous effects of the present disclosure are as follows. Provided is an ozone generating assembly, including a conductive pillar, an insulating sleeve sleeved on an outer periphery of the conductive pillar, a conductive sleeve sleeved on an outer periphery of the insulating sleeve, and insulating brackets arranged at two ends of the conductive pillar and used to arrange an inner wall of the conductive sleeve and an outer wall of the conductive pillar in parallel and at an interval. Air guiding holes are uniformly distributed on an outer peripheral surface of the conductive sleeve, and an ozone channel is formed by the air guiding holes and a gap between the inner wall of the conductive sleeve and an outer wall of the insulating sleeve. By the structure design of the ozone generating assembly and the arrangement of the ozone channel, ozone release efficiency and heat dissipation efficiency of the ozone generating assembly are effectively improved. Further provided is an ozone generator, which is low in energy consumption, good in heat dissipation effect, and high in ozone release efficiency.

### BRIEF DESCRIPTION

Some of the embodiments will be described in detail, with reference to the following figures, wherein like designations denote like members, wherein:

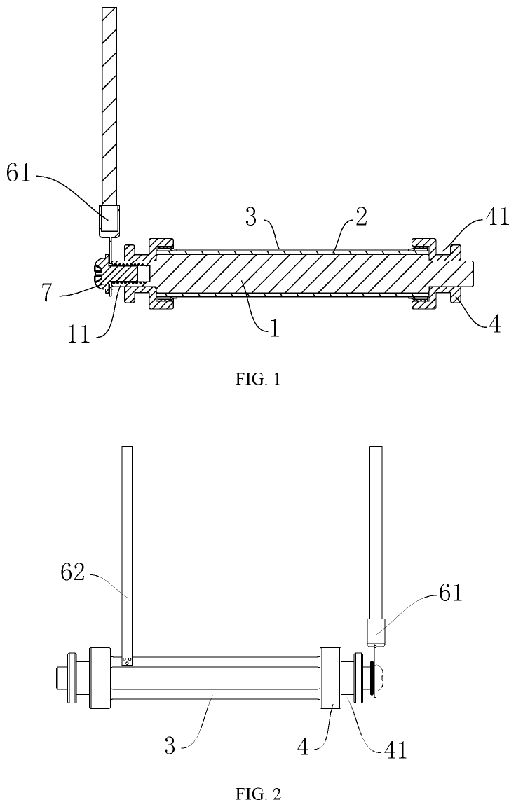

FIG. 1 is a sectional view illustrating an ozone generating assembly of the present disclosure;

FIG. 2 is a structural schematic diagram illustrating an ozone generating assembly of the present disclosure;

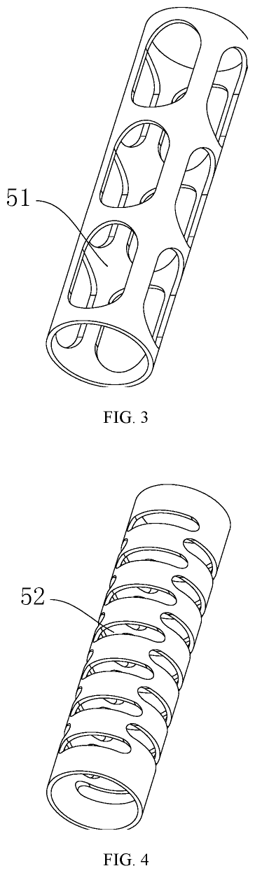

FIG. 3 is an axonometric view illustrating a first form of a conductive sleeve in FIG. 2;

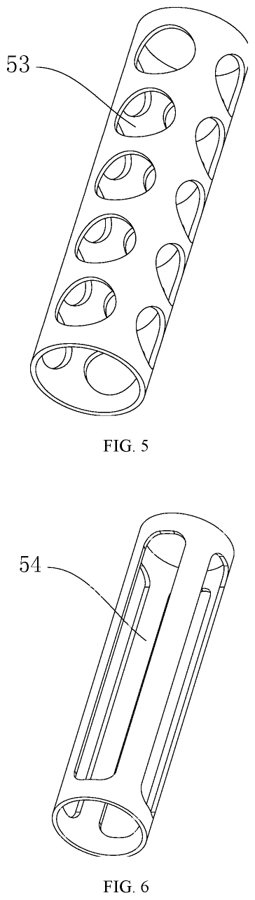

FIG. 4 is an axonometric view illustrating a second form of the conductive sleeve in FIG. 2;

FIG. 5 is an axonometric view illustrating a third form of the conductive sleeve in FIG. 2;

FIG. 6 is an axonometric view illustrating a fourth form of the conductive sleeve in FIG. 2; and

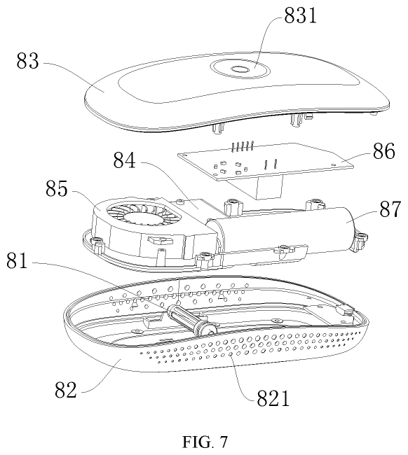

FIG. 7 is an exploded view illustrating an ozone generator of the present disclosure.

### DETAILED DESCRIPTION

Hereinafter the technical schemes of the present disclosure will be further described in conjunction with accompanying drawings and embodiments.

As shown in FIG. 1 to FIG. 7, provided is an ozone generating assembly, including a conductive pillar 1, an insulating sleeve 2 sleeved on an outer periphery of the conductive pillar 1, a conductive sleeve 3 sleeved on an outer periphery of the insulating sleeve 2, and insulating brackets 4 respectively arranged at two ends of the conductive pillar 1 and used to arrange an inner wall of the conductive sleeve 3 and an outer wall of the conductive pillar 1 in parallel and at an interval. Air guiding holes 51, 52, 53 and 54 are uniformly distributed on an outer peripheral surface of the conductive sleeve 3. An ozone channel is formed by the air guiding holes and a gap between the inner wall of the conductive sleeve 3 and an outer wall of the insulating sleeve 2.

In the present embodiment, in order to facilitate the fixing of the ozone generating assembly after the ozone generating assembly is assembled, an outer peripheral surface of each of the insulating brackets 4 is provide with a ring shaped positioning groove 41 for conveniently positioning. In addition, one end of the conductive pillar 1 is provided with a first electrode 61. The outer peripheral surface of the conductive sleeve 3 is welded with a second electrode 62.

In the present embodiment, in order to effectively improved conductive efficiency and heat dissipation efficiency, the conductive pillar 1 and the conductive sleeve 3 are made of steel 304.

In addition, each of the two ends of the conductive pillar 1 is provided with a fixing shaft 11 extending outwards. Each of the insulating sleeves 4 is sleeved on a respective fixing shaft 11. In order to facilitate the fixing of the first electrode 61, an end portion of the fixing shaft 11 at one end of the conductive pillar 1 is screwed to a fixing screw 7 for compacting the first electrode 61.

In another embodiment, in order to improve ozone conversion efficiency, as shown in FIG. 3 to FIG. 6, each of the air guiding holes 51, 52, 53 and 54 is arranged in various forms such as a circular hole, a waist shaped hole, a long strip shaped hole or an oval hole, which also greatly improves the heat dissipation efficiency of the ozone generating assembly.

Provided is an ozone generator, including the ozone generating assembly 81 as described above, a case for accommodating the ozone generating assembly 81 and disposed with the ozone generating assembly 81, an air guiding cover 84 covered on an outer periphery of the ozone generating assembly 81, a fan 85 disposed inside the case and connected to the air guiding cover 84 and penetrating through the air guiding cover 84, and an electric control assembly electrically connected to the fan 85 and the ozone generating assembly 81.

In another embodiment, the electric control assembly includes a circuit board 86 disposed above the air guiding cover 84, and a lithium battery 87 arranged in a cavity between a lower case 82 and an upper case 83 and electrically connected to the circuit board 86. One end of the circuit board 86 is provided with a mini USB charging interface. In addition, in order to facilitate the manipulation of the electric control assembly, a key 831 is arranged on a central portion of an upper surface of the upper case 83. The key 831 is electrically connected to the circuit board 86.

In another embodiment, in order to improve the ozone conversion efficiency of the ozone generator and accelerate the inflow and outflow of the airflow, a side wall of a periphery of the lower case 82 is uniformly provided with air inlets 821, and an air exhausting hole is arranged on and configured to penetrate through a bottom surface of the lower surface 82 below the ozone generating assembly 81. Thereby, under the auxiliary action of the fan 85, the air is quickly contacted with the ozone generating assembly 81, to perform the effective ozone conversion.

Meanwhile, by the active blowing of the airflow, the heat dissipation efficiency of the ozone generating assembly 81 can be improved, the ozone flow rate in the ozone channel can be accelerated, and the ozone can be effectively released outward by the air exhausting hole below the ozone generating assembly 81.

The technical principles of the present disclosure have been described above in conjunction with embodiments. The description is only used to explain the principles of the present disclosure and is not intended to limit the protection scope of the present disclosure in any form. Based on the explanation herein, other specific embodiments of the present disclosure occurring to those skilled in the art without making inventive labor are within the protection scope of the present disclosure.

What is claimed is:

1. An ozone generating assembly, comprising:
a conductive pillar;
an insulating sleeve sleeved on an outer periphery of the conductive pillar;
a conductive sleeve sleeved on an outer periphery of the insulating sleeve; and
insulating brackets arranged at two ends of the conductive pillar and used to arrange an inner wall of the conductive sleeve and an outer wall of the conductive pillar in parallel and at an interval;
wherein air guiding holes are uniformly distributed on an outer peripheral surface of the conductive sleeve, and an ozone channel is formed by the air guiding holes and a gap between the inner wall of the conductive sleeve and an outer wall of the insulating sleeve.

2. The ozone generating assembly according to claim 1, wherein each of the air guiding holes is a circular hole, a waist shaped hole, or an oval hole.

3. The ozone generating assembly according to claim 1, wherein a fist electrode is arranged at one end of the conductive pillar, and a second electrode is welded to the outer peripheral surface of the conductive sleeve.

4. The ozone generating assembly according to claim 1, wherein a ring shaped positioning groove is arranged on an outer periphery surface of the insulating bracket.

5. The ozone generating assembly according to claim 1, wherein the conductive pillar is a metal pillar, each of the two ends of the conductive pillar is provided with a fixing shaft extending outward, and each of the insulating brackets is sleeved on a respective fixing sleeve.

6. The ozone generating assembly according to claim 3, wherein an end portion of the fixing shaft at one end of the conductive pillar is screwed to the first electrode.

7. An ozone generator, comprising:
an ozone generating assembly according to claim 1;
a case, configured to accommodate the ozone generating assembly and disposed with the ozone generating assembly;
an air guiding cover, covered on an outer periphery of the ozone generating assembly;
a fan, disposed in the case, connected to the air guiding cover and penetrating through the air guiding cover;
an electric control assembly, electrically connected to the fan and the ozone generating assembly.

8. The ozone generator according to claim 7, wherein the electric control assembly comprises a circuit board disposed above the air guiding cover, and a lithium battery arranged in the case and electrically connected to the circuit board.

9. The ozone generator according to claim 7, wherein air inlets are uniformly distributed on a side wall of a periphery of the case, and an air exhausting hole is arranged on and configured to penetrate through a bottom surface of the case below the ozone generating assembly.

10. The ozone generator according to claim 8, wherein a key is arranged on a central portion of an upper surface of the case, and electrically connected to the circuit board.
